(19) United States
(12) Patent Application Publication
(10) Pub. No.: US 2006/0095960 A1
(43) Pub. Date: May 4, 2006

(54) Data center topology with transparent layer 4 and layer 7 services

(75) Inventors: Mauricio Arregoces, Rancho Palos Verdes, CA (US); Maurizio Portolani, Milpitas, CA (US); Pere Monclus, San Francisco, CA (US); Anurag Kahol, Fremont, CA (US); Venkateshwar Rao Pullela, San Jose, CA (US); Saravanakumar Rajendran, San Jose, CA (US); Dileep K. Devireddy, San Jose, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/084,311

(22) Filed: Mar. 17, 2005

Related U.S. Application Data
(60) Provisional application No. 60/623,810, filed on Oct. 28, 2004.

(51) Int. Cl. G06F 15/16

(52) U.S. Cl. 726/11

(57) ABSTRACT

A data center topology routes traffic between internal sub-nets and between a sub-net and an outside network through a common chain of services. The data center topology employs transparent layer 7 and layer 4 services on a common chassis or platform to provide routing, load balancing and firewall services while reducing the number of devices necessary to implement the data center and simplifying configuration.

### CROSS-REFERENCES TO RELATED APPLICATIONS

This application claims priority from commonly assigned provisional patent application entitled “Data Center Network Design And Infrastructure Architecture” by Mauricio Arregoces and Maurizio Portolani, application No. 60/623,810, filed Oct. 28, 2004 the entire disclosure of which is herein incorporated by reference.

### BACKGROUND AND SUMMARY OF THE INVENTION

Data centers are an integral element in supporting distributed client/server computing. Data centers enable the use of powerful applications for the exchange of information and transaction processing and are critical to the success of modem business. A typical n-tier data center uses multiple physical devices. These devices, shown in FIG. 1, may include a firewall 10 that provides access security for a server farm having web servers 11 and 12, a Layer 3 switch 13 that functions as a router and a content switch 14 to load balance traffic to web servers 11 and 12. Each of the web servers 11 and 12 have dual network interface cards and are further connected to a backend network through switches 15 and 16, a second tier of firewalls 17 and a content switch 18 to a tier of servers such as application servers 19 and 20. Other servers, such as mail servers, file servers, DNS servers, streaming servers or servers directed to other specific tasks may be included in the data center as is well understood in the art.

Application servers 19 and 20 are further connected to another backend network through switches 21 and 24, another tier of firewalls 22 and a content switch 23 to a tier of database servers 25 and 26.

One problem with the topology of the n-tier data center is that it requires too many physical devices, is expensive to set up and operate and is difficult to manage. Thus setting up an n-tier data center to service requests from a large number of users is not only expensive but also difficult to maintain. What is needed is a simplified data center topology that reduced the number of physical devices, is inexpensive to set up and easy to maintain.

To address this need, an embodiment of a prior art data center is shown in FIG. 2 with a simplified topology. In this prior art embodiment, a firewall eliminates the need for a separate physical firewall device at more than one tier. Thus, as shown in FIG. 2, a single virtual firewall 28 interfaces a plurality of content switches 29-31, web servers 32, application servers 33 and database servers 34 to router 25. Virtual Local Area Networks or VLANs 35-37 couple the servers 32, 33 and 34, and the respective content switches 29-31 to firewall 28. Traffic from a server, such as one web server 32 to a database server 34 will pass through firewall 28 to be routed to database server 34 by router 25. The traffic must pass through firewall 28 a second time before reaching database servers 34 thereby providing secure communication between servers coupled to different VLANs. While this embodiment reduces the number of devices, it is still expensive to set up and maintain. Thus, by replacing the multiple firewalls 10, 17, and 22 shown in FIG. 1 with a single firewall 28, the data center topology in FIG. 2 provides the same functionality but with considerably fewer physical devices because of the elimination of switches 15, 16, 21 and 24.

In another data center topology, using the single firewall 28 coupled by a content switch reduces the number of physical devices. By tightly linking to the firewall 28 with content switch 38 operating in bridge mode further simplification is achieved. The embodiment shown in FIG. 3 affords further reduction in the number of physical devices because content switch 38 and firewall 28 are mounted in one common chassis 39 as two service blades. In this embodiment, firewall 28 and content switch 38 perform the work of up to ten physical devices compared to the topology shown in FIG. 1. While the topology shown in FIG. 3 is greatly simplified, the transfer of traffic between the content switch, firewall and router is not easily configured. Further, the firewall does not preserve traffic segmentation and it must still perform some routing functions. Similarly, the content switch must also perform some routing functions in addition to its load balancing functions, which is undesirable.

To overcome these disadvantages of the prior art data center topology, a topology in accordance with the present invention efficiently routes traffic on internal sub-nets as well as traffic routed to an outside network. The data center topology employs transparent layer 7 and layer 4 services on a common chassis or platform to provide routing, load balancing and firewall services to simplify data center topology. Advantageously, the number of devices necessary to implement the data center is reduced and configuration is simplified.

The foregoing and additional features and advantages of this invention will become apparent from the detailed description and review of the associated drawing figures that follow.

### BRIEF DESCRIPTION OF THE DRAWINGS

FIG. 1 is a simplified block diagram illustrating prior art data center topology.

FIG. 2 is another simplified block diagram illustrating prior art one-arm data center topology.

FIG. 3 is a simplified block diagram illustrating a prior art data center topology having transparent Layer 4 and Layer 7 services.

FIG. 4 illustrates an improved data center topology having transparent Layer 4 and Layer 7 services in accordance with an embodiment of the present invention.

FIG. 5 shows a traffic flow diagram in accordance with an embodiment of the present invention.

FIG. 6 shows another traffic flow diagram in accordance with an embodiment of the present invention.

FIG. 7 illustrates another embodiment of the present invention.

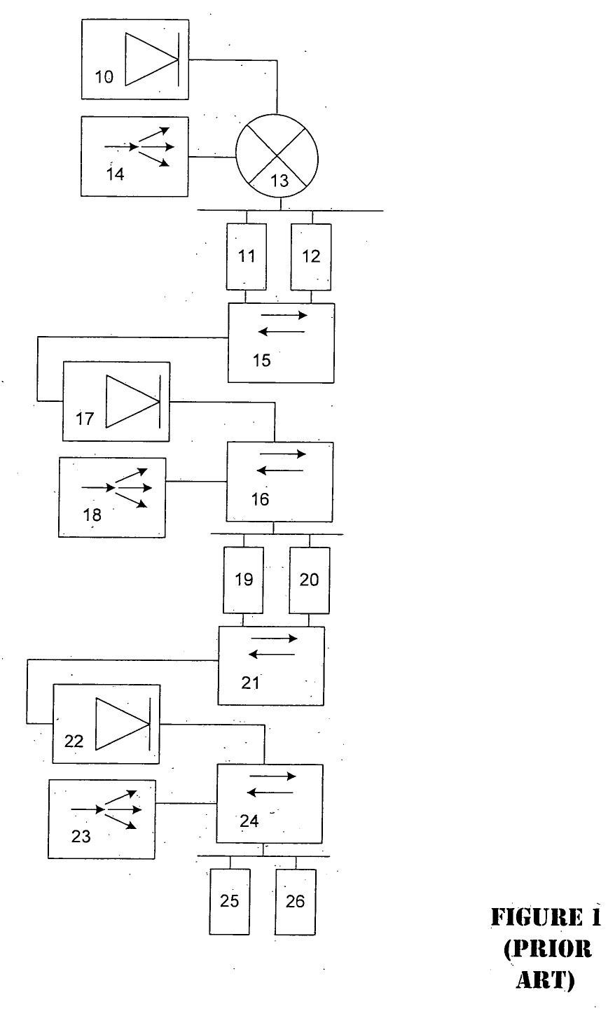

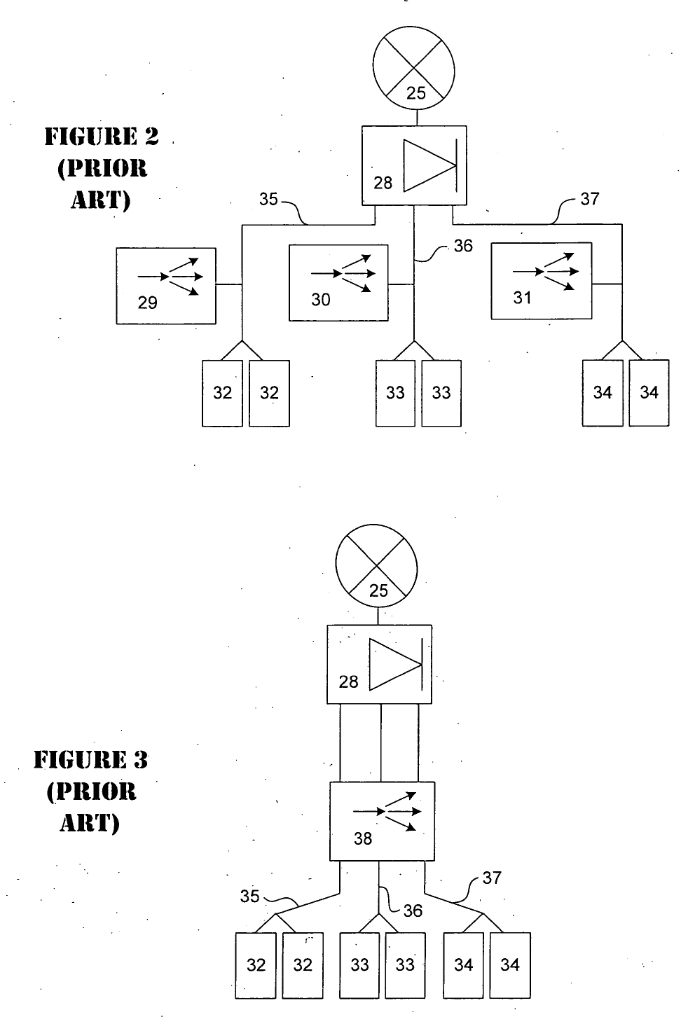

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, parts, and/or the like. In other instances, well-known structures, materials, or operations are not specifically shown or described in detail to avoid obscuring aspects of embodiments of the present invention.

To overcome the disadvantages of prior art data center topology, a topology in accordance with the present invention efficiently routes traffic between internal sub-nets as well as traffic destined to or arriving from an outside network. The data center topology employs transparent layer 7 and layer 4 services on a common chassis or platform to provide routing, load balancing and firewall services to simplify data center topology. Advantageously, the number of devices necessary to implement the data center is reduced and configuration is simplified.

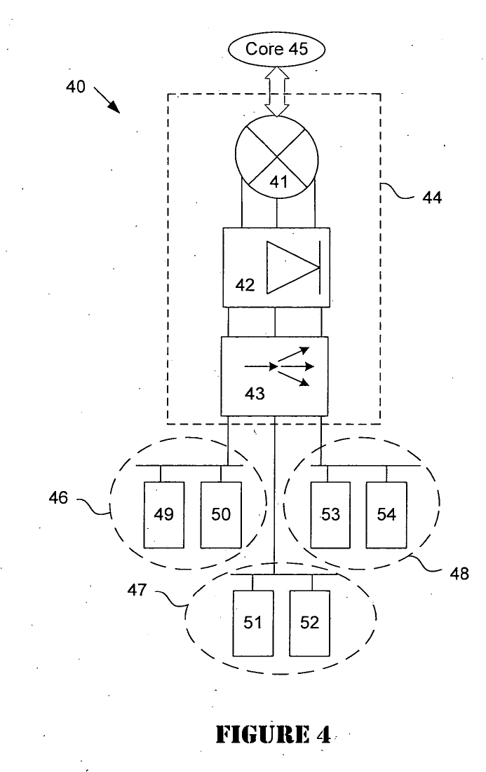

Referring now to the drawings more particularly by reference numbers, an embodiment of a representative data center 40 is shown in FIG. 4 that further simplifies the data center topology in accordance with the present invention. In this embodiment, a transparent firewall provides multiple outside interfaces that permits efficient routing of service requests between inside sub-nets and between inside sub-nets and the outside network. Data center 40 comprises a router 41, a transparent firewall component 42 and a content switch component 43 all on a common chassis 44. The common chassis eliminates the need to provide network or power cabling for components 42 and 43 thereby minimizing costs. The data center topology reduces the number of devices to provide transparent layer 7 and layer 4 services.

Router 41 is a device, or network appliance, that determines the next network point to which information packets, or traffic, should be forwarded toward its destination. Router 41 in one preferred embodiment is either the Cisco Catalyst 6500 or the Cisco 7600 series router, both of which are commercially available from Cisco Systems, the parent corporation of the present assignee. In some network embodiments, router 41 may be implemented in software executing in a computer or it may be part of a network switch. Router 41 is connected to at least two networks, such as external core network 45 and the internal network of data center 40.

Functionally, the router 41 determines the path to send each information packet based on the router's understanding of the state of the networks. Router 41, functions as the gateway for sub-nets 46, 47 and 48. Each sub-net includes a plurality of servers that are illustrated by servers 49 and 50 in sub-net 46, servers 51 and 52 in sub-net 47 and servers 53 and 54 in sub-net 48. The server tier in each sub-net may comprise various types of servers such as application servers, database servers, mail servers, file servers, DNS servers or streaming servers by way of example.

Router 41 creates and maintains available routes and uses this information to determine the best route for a given packet traversing either to or from sub-net, 46, 47 or 48. Although each sub-net 46-48 is illustrated having a pair of servers, it is to be understood that a subnet may comprise many nodes coupled by a local area network or LAN. A contiguous range of IP address numbers identifies each node in the sub-net. Subnets are often employed to partition networks into logical segments for performance, administration and security purposes.

Rather than provision each sub-net with a dedicated firewall, firewall component 42 is preferably an integrated firewall module marketed by Cisco as the Firewall Services Module (FWSM). The FWSM may be configured to provide multiple virtual firewalls within a single hardware appliance. Firewall 42 provides statefull connection-oriented firewall services and may function as the default gateway for each sub-net. The firewall creates a connection table entry for each session flow and applies a security policy to these connection table entries to control all inbound and outbound traffic.

Firewall component 42 functions to enforce network access policy and prevent unauthorized access to data center sub-nets 46-48. A network access policy defines authorized and unauthorized users of the servers as well as the types of traffic, such as FTP or HTTP that is allowed across the network. Firewall component 42 controls access to certain portions of the data center by defining specific source address filters that allow users to access certain sub-nets but not other sub-nets. It is preferred that firewall component 42 does not perform any routing functions.

Rather than placing discrete firewalls at all access points where a sub-net sends and receives traffic from other networks or sub-nets, the present invention includes a firewall configured as multiple virtual firewalls, called security contexts, within the same hardware appliance. A security context is a virtual firewall that has its own security policies and interfaces.

In another embodiment, firewall component 42 is a transparent virtual firewall so it operates in-line with the sub-net it is protecting and does not require any additional sub-nets than 46-48. Firewall component 42 does not require the configuration of static routes on 41, 42 or 43. Another key advantage of the transparent virtual firewall is that has no IP addresses so it is unreachable and invisible to the outside world.

In the topology shown in FIG. 4, content switch component 43 functions as a bridge forwarding data traffic from the firewall component 42 to a node in the sub-net. In its bridge function, content switch component 43 inspects incoming traffic and decides whether to forward to a node in the sub-net with or without load balancing.

Content switch component 43 provides Layer 4-7 services for HTTP requests, FTP file transfer, e-mail and other network software services. Content switch component 43 can access information in the TCP and HTTP headers of the packets to determine the complete requested URL and any cookies in the packet. Content switch component 43 uses this information to load balance and to route requests to the appropriate web server or application server. Once content switch component 43 determines the best server for an inbound request, it is passed to that server. Because content switch component 43 functions in the bridge mode, all traffic between any two sub-nets must pass through firewall 42 so no segment of the data center is left unprotected.

Virtualization of components 42 and 43 enable segmentation of traffic flow and efficient delivery of Layer 3 services. Traffic flow is through a chain of firewall and load balancing services and then routed to the destination. In a preferred embodiment, firewall component 42 is a fabric connected virtual firewall coupled to router in a transparent fashion. In the transparent mode, the default gateway for the servers is router 41 rather than firewall component 42.

Components 42 and 43 are preferably fabric connected. Switching fabric is the combination of hardware and software that moves traffic coming in to one of the components out to the next component. Switching fabric includes the switching infrastructure linking nodes, and the programming that allows switching paths to be controlled. The switching fabric is independent of any bus technology and infrastructure. If one or both of components 42 and 43 are linked by bus technology, care must be taken to ensure that bus transfers will not constrain traffic flow.

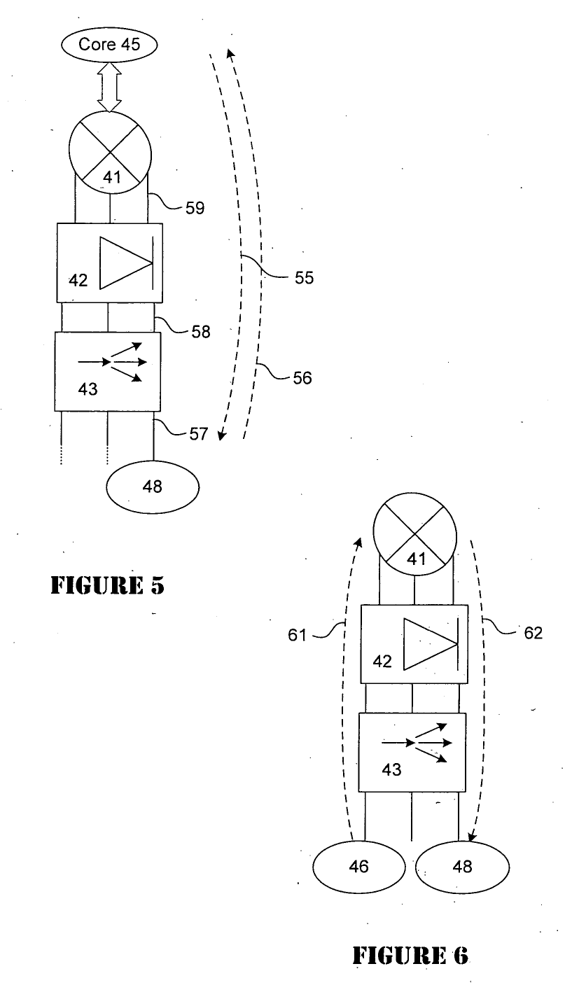

FIG. 5 illustrates traffic flow between a sub-net of data center 40 and the outside network core 45 as illustrated by dashed lines 55 and 56. Outside traffic 55 is routed from core 45 to sub-net 48 by router 41, which applies routing protocols to the traffic. If the traffic complies with the security policies, firewall 42 passes the traffic to content switch component 43, which selects the appropriate server within the sub-net. Return traffic 56 traverses the same path, passing through both content switch component 43 and firewall component 42 before being routed to the requester by router 41. Advantageously, with traffic segregation and the fabric connection, there is no requirement to utilize VLANs between chassis 44 and sub-nets 46-48.

FIG. 6 illustrates traffic flow between two sub-nets, such as from sub-net 46 to sub-net 48. Traffic traverses paths as indicated by dashed lines 61 and 62. Specifically, traffic from sub-net 46 follows a path that protects against internal and external security breaches as any request to a server in different subnet is always subject to stateful inspection by firewall component 42. Similarly, any outgoing traffic from, for example, server 48, must go through content switch component 43, firewall component 42 and router 41 on the outgoing path 62.

All data center traffic, whether originating from the outside network or between sub-nets, passes through the same chain of services. Further since all traffic passes through firewall component 42 all traffic is stateful inspected even for server-to-server communication within the data center. Advantageously, since the firewall component is dedicated to stateful inspection and is not permitted to provide any routing functions, it need not be configured for routing functions.

The primary purpose of content switch component 43 is to implement load balancing policies. These policies describe how connections and requests are to be distributed across the servers in each sub-net eligible to receive the traffic. Other policies may be implemented by component 43. For example, component 43 may be configured to describe persistence policies to determine whether a connection must stay with a particular server in the sub-net until a particular transaction or unit of work is complete. Component 43 may be configured to implement server failure policies or other content-specific policies to specify how different types of content are to be treated. Regardless of the policy, it is to be understood that component 43 applies Layer 7 policy and its primary role is to manage the delivery of messages to and from specific devices or servers based upon the requirements of the application and the devices.

Since neither the firewall component 42 nor the content switch component 43 is not permitted to function as a router, configuration is limited primarily to implementing security policy and load balancing functions, respectively. Thus, there is no need to configure OSPF or other routing protocol at either the firewall or content switch thereby simplifying the task of setting up and maintaining the data center.

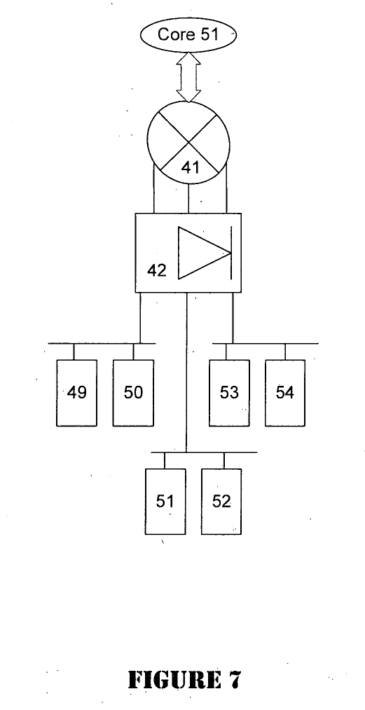

In some applications, a data center such as data center 65, which is shown in FIG. 7, do not require load balancing. In such applications, the present invention is straightforward to implement without a content switch. Specifically, router 41 is fabric coupled to firewall component 42 both of which preferably share a common chassis 66. Firewall 42 is also fabric coupled to the plurality of sub-nets.

It is a critical feature of the present invention that all routing functions reside in router 41. It is also preferred that router 41, firewall component 42 and load balance component 43 be on a common chassis. Further, to ensure that all traffic is statefully inspected for security by firewall component 42, it is important that the content switch component 43 functions in the bridge mode. This restriction ensures that a server in one sub-net will not have direct access to a server in another sub-net.

Since the firewall and content switches are chained in the transparent mode, traffic is segregated and must flow through the same chain of services on both in-bound and out-bound paths. To avoid backplane oversubscription, it is preferred that both the firewall component 42 and the content switch component 43 be fabric connected devices to allow segmented traffic flow through the entire chain.

Accordingly, the present invention provides a new data center topology that uses a chained transparent firewall and a load-balancing module and achieves segregation between traffic paths. The topology replaces multiple appliances with a simplified configuration of a L3 switch, firewall and load balancing in a single chassis which functions as a server farm gateway. This concept expands on the transparent firewall module combined with a VLAN to replace switches and multiple firewall appliances with a single firewall blade. A further enhancement includes a content switch blade that utilizes the bridge mode to manage traffic flow. The sequential topology eliminates the need to configure the firewall and the content switch with routing configurations. The firewall is configured only with security policies and the content switch is configured only with load balancing policies so system-configuration is simplified.

Accordingly, the present invention provides a data center having a secure and scalable topology. The data center has a secure internal segment that comprises a virtual transparent load balancing device chained to a virtual transparent firewall and a router in a data center. This topology may use existing Cisco products in a manner that differs from the designed use so it is preferred that the devices be fabric coupled to eliminate slow bus transfers.

Although the invention has been described with respect to specific embodiments thereof, these embodiments are merely illustrative, and not restrictive of the invention. For example, the network may include different routers, switches, servers and other components or devices that are common in such networks. Further, these components may comprise software algorithms that implement connectivity functions between the network device and other devices in a manner different from that described herein.

In the description herein, specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

As used herein the various databases, application software or network tools may reside in one or more server computers and more particularly, in the memory of such server computers. As used herein, “configuration” of a network device may include the storage and execution of computer code from memory locations associated with said network device to determine how network traffic is handled. As used herein, “memory” for purposes of embodiments of the present invention may be any medium that can contain, store, communicate, propagate, or transport the program for use by or in connection with the instruction execution system, apparatus, system or device. The memory can be, by way of example only but not by limitation, an electronic, magnetic, optical, electromagnetic, infrared, or semiconductor system, apparatus, system, device, propagation medium, or computer memory.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A data center comprising:
a router;
a virtual transparent firewall coupled to said router;
a plurality of sub-nets coupled to said firewall such that traffic between different sub-nets is segregated by said firewall;
said router and firewall configured for routing traffic such that all traffic to a sub-net receives stateful inspection.

2. The data center of claim 1 whereby said firewall is configured for implementing a security policy of said data center.

3. The data center of claim 1 whereby said firewall is configured for implementing a security policy for each sub-net of said data center.

4. The data center of claim 1 wherein said firewall is coupled by fabric to said router.

5. The data center of claim 1 further comprising a content switch coupled to said firewall and to each of said sub-nets.

6. The data center of claim 5 wherein said content switch is configured for implementing a load balancing policy for said data center.

7. The data center of claim 6 wherein said content switch is implements a different load balancing policy for at least one of said sub-nets.

8. The data center of claim 7 wherein said content switch is fabric connected to said firewall.

9. The data center of claim 5 wherein said firewall and said load balancer component are chained in a transparent mode so that traffic between sub-nets or between a sub-net and an outside network goes through a consistent chain of services.

10. The data center of claim 5 wherein said firewall and said load balancer component are chained in a transparent mode so that traffic between sub-nets or between a sub-net and an outside network and all traffic between sub-nets or between a sub-net and said outside network is segregated and includes a stateful inspection.

11. A data center comprising a router, firewall and content switch on a common chassis and a plurality of sub-nets coupled by fabric to said content switch whereby said firewall is chained to said content switch such that traffic goes through a common chain of Layer 7 and Layer 3 services.

12. The data center of claim 11 wherein said router performs all routing and switching functions for said data center.

13. The data center of claim 12 wherein said firewall is configured to implement stateful inspection of said traffic.

14. The data center of claim 13 wherein said content switch is configured to implement load balancing policy for said data center.

15. The data center of claim 14 wherein traffic between subnets is segregated and routed by said router such that all traffic is subject to a common chain of services.

16. The data center of claim 15 wherein said data center is coupled to an outside network core and traffic between said outside network core and one of said sub-nets is subject to a common chain of services for both in-bound and out-bound traffic.

17. In a data center, a method for stateful inspection of all traffic comprising:
defining a network chain for providing Layer 7 services;
configuring said chain to perform stateful inspection to all traffic; and
routing all traffic through said chain.

18. The stateful inspection method of claim 15 further comprising:
configuring a virtual transparent firewall to implement security policy for said data center;
configuring a virtual transparent content switch to implement load balancing policy for said data center; and
routing all traffic through said configured firewall and said content switch.

19. The stateful inspection method of claim 18 wherein said stateful inspection, load balancing and routing steps are performed by a virtual transparent content switch fabric coupled to a virtual transparent firewall which in turn is fabric coupled to a router, said content switch, firewall and router having a common chassis.

20. The stateful inspection method of claim 19 wherein said router functions as a gateway for said traffic.

21. The stateful inspection method of claim 18 wherein said content switch component functions in the bridge mode.
